(19) United States
(12) Patent Application Publication
(10) Pub. No.: US 2008/0085744 A1
(43) Pub. Date: Apr. 10, 2008

(54) Cellular phone vehicle stereo interface cable

(76) Inventor: Romeo Antonio Duarte, Houston, TX (US)

Correspondence Address: ROMEO A. DUARTE, 7535 NAVIDAD RD., HOUSTON, TX, 77083, US

(21) Appl. No.: 11/903,653

(22) Filed: Sep. 24, 2007

Related U.S. Application Data
(60) Provisional application No. 60/846,962, filed on Sep. 25, 2006.

(51) Int. Cl. H04M 1/00

(52) U.S. Cl. 455/569.2

(57) ABSTRACT

The present invention provides a modular cellular phone/vehicle stereo interface cable operable to support voice communication when connected to a cellular device and a unidirectional microphone arranged within the cable while wirelessly transfer the incoming voice signal of a remote caller to a vehicle stereo system to provide a hands and ear free communication. Due to the electromagnetic radiation hazard of cellular devices to the brain and other internal organs of the human body; it is required to keep the device away from the users. Wireless communication to the vehicle stereo is achieved with the use of a radio frequency modulator (radio transmitter) and this type of communication can be establish with any vehicle stereo system but not limited to. Additionally a direct connection also can be establish with some vehicle stereo systems that includes a standard 3.5 mm audio input female socket for the purpose of input music from other electronic devices, this audio input connector is usually located in the glove box or in the center console of the vehicle, additionally some new stereo systems provides an audio input female connector located on the face plate of the stereo system. with the use of the cellular phone/vehicle stereo interface cable a hands and ear free bi-directional communication is established.

This nonprovisional application claims the benefits of prior provisional application No. 60/846,962 Filed on: Sep. 25, 2006

### FIELD OF THE INVENTION

The present invention relates generally to electronic communication Devices and more specifically to cellular phones. This invention provides a modular interface cables operable to support voice communication when connected to a cellular phone a unidirectional microphone and a radio frequency modulator while wirelessly transfer the remote voice data to a vehicle stereo system to provide a hands and ear free communication.

### BACKGROUND OF THE INVENTION

The use of cellular devices has spread all over the world and specially in the United States for the last few years and for almost all communities. In the present days still exist the hazard of the electromagnetic radiation that is present around the device. The cellular device is usually held near the ear of the person using that device and for relatively long period of time, this represent a risk for the brain and for other organs of the human body. Another hazard is in the use of a cellular device while operating a motor vehicle; where the driver becomes unfocused or distracted and unable to use both hands in case of an emergency maneuver.

There were many ways to reduce the radiation hazard of cellular phones, but most of them are in some way uncomfortable to be wearing for long period of Time as an example is the hands free earpiece and headset, what also in some cases reduce the voice quality and also reduce some outside sounds like sirens from inbound emergency vehicles or police patrols.

In the many attends to reduce the different risk is the developed of the blue tooth enable devices what in some ways contribute to reduce that risk, but with the disadvantage that not all phones and not all vehicles have blue tooth capabilities at this time.

There is the need to provide an effective way for handling wireless communication and more specifically from cellular devices to be set aside from the human brain, but also with hands and ear free capabilities and maintaining the voice quality.

### SUMMARY OF THE INVENTION

It is an object of the present invention to provide an effective way to connect a cellular device to a vehicle stereo system so that the phone can be held in a distance from the head and the body of a user.

It is another object of the present invention to provide a hands and ear free communication to help the driver to concentrate in his/hers duties.

It is another object of the present invention to provide a hands and ear free communication to be more comfortable to the user.

It is yet another object of the present invention to provide an effective way to connect a cellular device to a vehicle stereo system to retains the voice quality.

It is thus provided an interface cable to connect cellular phone to vehicle stereo system through which a user can hear and speak in the cellular phone from a distance establishing bi-directional communication, said device comprising:

The main interface cable with four conductor wires and of a “Y” shape that provides three different connections one at each end, each of different length and of different type, connections are establish with a microphone, radio frequency modulator and the cellular phone. If a vehicle provides an audio input connector no radio frequency modulator is need.

A unidirectional microphone that has to be installed on top of the steering column cover in the cabin and connect to the interface cables via 3.5 mm connector provides a more effective way for routing the cables inside the vehicle but no professional installation is required. The microphone is placed inside a special casing to provide more effective reception and less eco to be generated.

furthermore, in accordance with another preferred embodiment of the invention, the casing of the microphone is made of stiff material.

furthermore, in accordance with another preferred embodiment of the invention, the casing of the microphone provides a directional type microphone capabilities, comprising a low impedance unidirectional microphone located on the back part of the casing, cushion material between the low impedance microphone and the front of the casing were eight openings are made.

Furthermore, in accordance with another preferred embodiment of the present invention a 3.5 mm female audio connector specifically marked as microphone is located at another end in the interface cables to provide connectivity with the microphone.

Furthermore, in accordance with another preferred embodiment of the present invention at another end of the interface cables a 3.5 mm audio male connector specifically marked modulator is located. which provides connectivity with the radio frequency modulator. An adapter also can be use in the case the modulator has a male type connector.

furthermore, in accordance with another preferred embodiment of the invention, a direct connection can be establish with the 3.5 mm male connector specifically marked as modulator with some vehicles that provides an audio input female socket. Usually audio input connectors are located in glove box, center console or at the face plate in some new stereo systems.

Furthermore, in another preferred embodiment of the invention, the last end of the interface cable a 2.5 mm standard male connector is located; which provides connectivity with the cellular phone, it connects to the input/output socket of the cellular device.

Additionally, in accordance with another preferred embodiment of the invention, different adapters are made to provide connectivity with different brands of phones this adapters are capable to connect to the 2.5 mm male connector.

### BRIEF DESCRIPTION OF THE FIGURES

FIG. 1 illustrate a user talking through the cellular phone when connected to the interface cable, hands and ear free communication is established in accordance with the preferred embodiment of the present invention.

FIG. 2 illustrate a block diagram of the interface cables, in accordance with the preferred embodiment of the present invention.

FIG. 3 illustrate the parts layout of the interface cables, in accordance with the preferred embodiment of the present invention.

FIG. 4 illustrate an enlarge view of the connection between the cellular phone and the interface cables, in accordance with the preferred embodiment of the present invention.

FIG. 5 illustrate diferent adapters that can be made to conect other type of phone with different connectivity, in accordance with the preferred embodiment of the present invention.

FIG. 6 illustrate the wiring diagram of the interface cables, in accordance with the preferred embodiments of the present invention.

### DETAILED DESCRIPTION OF THE INVENTION AND FIGURES

Due to the electromagnetic radiation hazard of cellular devices to the brain and other internal organs of the human body; it is required to keep the device away from the users. Another hazard is when operating a motor vehicles were the driver becomes distracted when using the cellular phone as a handheld device. Is estimated that more than 140,000 traffic accidents each year are caused by the use of cellular phones, for this reasons some States started prohibiting the use of cellular phones while operating a motor vehicle without special hands-free devices. Example of this is the State of California.

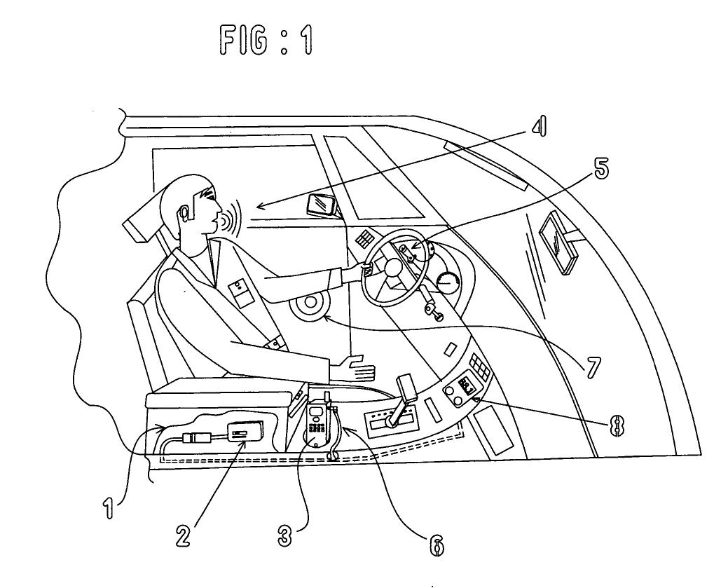

Reference is now made to FIG. 1 illustrating a user (driver) talking through the cellular phone 3, that is connected to the interface cables 6 which use a r/f (radio frequency) modulator 2 to wirelessly transmit voice data to the stereo system 8. Sound waves (voice) 4 are outbound from the users mouth to the microphone 5 which is connected to the interface cables 6 and which picks up the voice and sent it to the cellular phone 3 to be transmitted to the remote caller, the voice of the caller can be heard from the loud speaker 7. Speakers selection and volume can be controlled from the vehicle stereo 8.

The r/f modulator 2 can be seen from the cutaway view 1, it connects to interface cables 6 that can be hide behind plastic trims or inside the center console In the particular case that the vehicle includes an audio input connector, a direct connection can be establish with interface cables 6.

The frequency of transmission is controlled from the r/f modulator 2, that frequency (radio station) is memorized in the vehicle stereo system 8 for easy access when the phone 3 rings

The driver can perform normal driving, both hands on steering wheel is preferable 100% of the time, but activation of different devices in the cabin are been allow, example of this is the activation of the head lights, wipers etc or to turn radio 8 on and off or to change radio stations.

It is always recommended to set the phone 3 in auto answer mode, that way the users only responsibility will be to push one memory button on vehicle stereo 8.

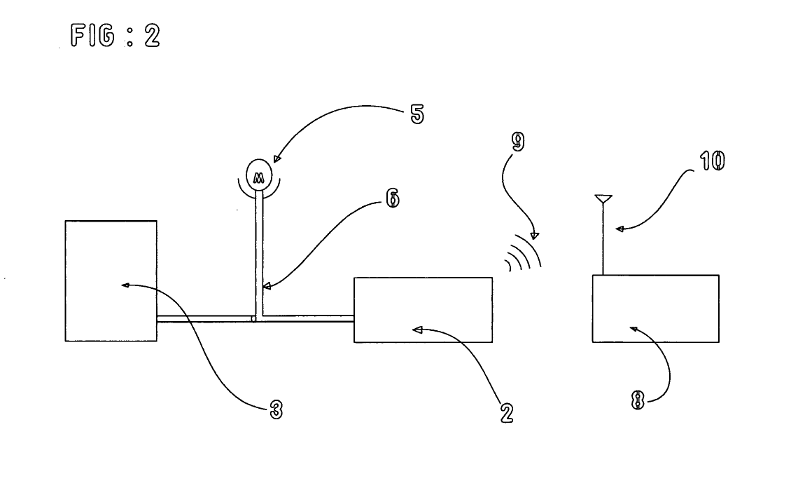

Reference is made to FIG. 2 illustrating a block diagram in accordance with the preferred embodiment of the present invention. Interface cables 6 is shown in a direct connection to cellular phone 3 microphone 5 and r/f modulator 2, radio waves 9 are outbound from modulator 2 toward the vehicle stereo antenna 10.

Cellular phone 3 and most cellular devices have many features like auto answer, or another one and very important for us is the voice recognition, it can be use to dial numbers with the push of a button, then you say the name of the person and the phone 3 does the dialing. The use of these features is essential for the use of this type of connection. We are getting the most of the phone 3 with a little help from the interface cables 6 which provide hands and ear free capabilities.

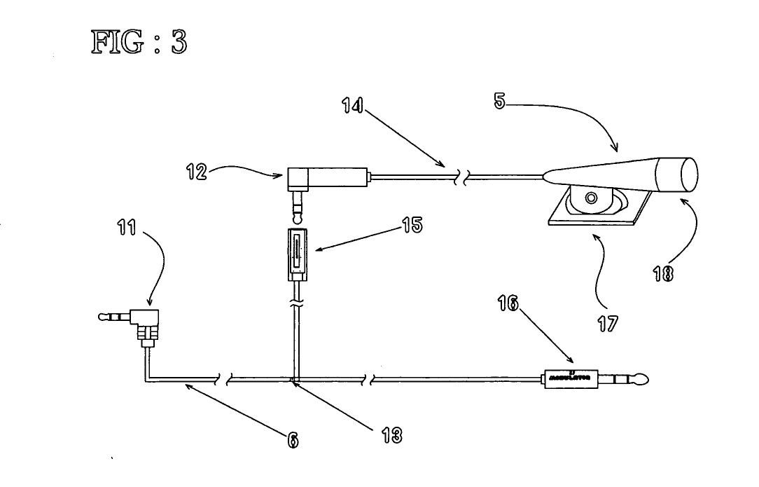

Reference is made to FIG. 3 illustrating the parts involve in the making of the interface cables 6. At one end of the interface cable 6 a 2.5 mm standard male connector 11 is arrange in the cables, that is the most common type of head set connections, from that connector a cable with four conductors wires extend to splitter point 13 and of about three feet in length and made of flexible conductor material coated with an insulator.

From splitter point 13 the four conductor cable divides into two pairs, one pair of wires going to the 3.5 mm standard female connector 15 while the other pair goes to the 3.5 mm standard male connector 16. The wires going to the connector 15 is in a single cable, made of flexible material and is four feet in length, the other two wires in a single cable going to connector 16 is also made of flexible material and of five feet in length.

Microphone 5 is a low impedance unidirectional microphone, its sensitivity range is −51+/−4 dB and connects to the interface cable via a 3.5 mm audio male connector 12 which connects to female connector 15. The cable 14 of the connection for the microphone 5 may vary from six to eight feet.

The base 17 of the microphone 5 may contain a sticky pad to affix the microphone on top of the upper steering column cover.

A noise deflector 18 can be attached in front of microphone 5 in order to reduce any eco that may be generated if the user exceed with the amount of volume and made of stiff material.

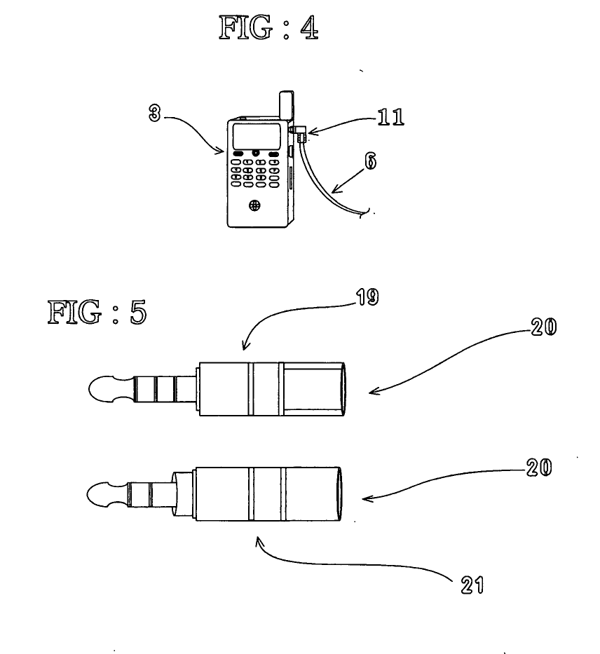

Reference is made to FIG. 4 illustrating an enlarge view of the connection between cellular phone 3 and interface cables 6 by using a standard 2.5 mm male connector 11.

Reference is made to FIG. 5 different types of adapters 19 and 21 can be made to provide connectivity with different brands of cellular devices, the design of adapters are not limited to this illustrations.

Adapters 19 or 21 can be attached to the interface cable 6 when connected directly with connector 11. Most cellular phones are cover with this adapters.

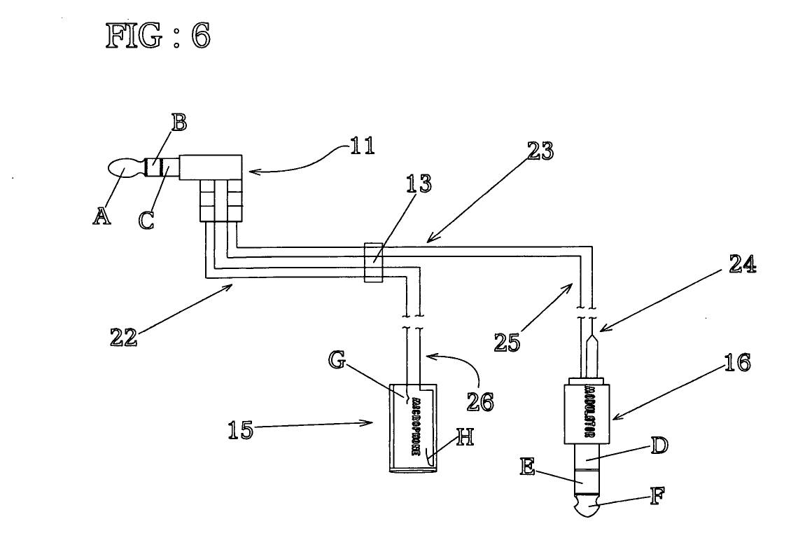

Reference is made to FIG. 6 which illustrate a wiring diagram of the cellular phone/vehicle stereo interface cables. From 2.5 mm male connector 11 a cable with four conductor wires extend until they reach splitter point 13 and devices in two pairs. Two conductor wires 23 and wire 25 in a single cable said first transmission cable, connects to the 3.5 mm male connector 16 marked as modulator continuity between terminals C of conector 11 and D of conector 16 is required, this is the ground of the circuit, continuity is achived through conductor wire 25. Continuity is also required for terminals B of conector 11 and terminal F of connector 16 were continuity is achived through wire 23. Splittter 24 allow terminals E and F to connect together in order to use two channels audio.

Two other wires from splitter point 13, 22 and wire 26 in a single cable said second transmission cable, connects to the female connector 15 marked as microphone to provide connectivity with the microphone 5. According with the preferred embodiment of the present invention. Continuity between terminals A of connector 11 and terminal G of connector 15 is required through wire 22 and also continuity between terminals C (ground) and H is need in order to complete the circuit, this is achieved through wire 26.

It should be clear that the description of the embodiments and attached figures set forth in this specification serves only for a better understanding of the invention.

It should also be clear that a person in the art, after reading the present specification could make adjustment or amendments to the attached figures and above described embodiment.

What is claim is:

1. A cellular phone/vehicle stereo interface cable operable to support voice communication between cellular phone and a vehicle stereo when connected to a radio frequency modulator and a cellular phone or with direct connection to an audio input socket of a vehicle stereo system.
The cellular phone/vehicle stereo interface cable comprising:
A) A hands free unidirectional microphone in an enclosure that provides directional microphone capabilities.
B) A first transmission cable with a 3.5 mm female connector for connecting the hands free unidirectional microphone and the voice input terminal of the cellular device.
C) A second transmission cable with a 3.5 mm male connector for connecting the radio frequency modulator and the voice output terminal of the cellular device.
D) A second transmission cable for establishing direct connection with an audio input socket of a vehicle stereo system.
E) A 2.5 mm male connector, located at one end of the first transmission cable for establishing connectivity with the voice input terminal of the cellular device.
The 2.5 mm connector located at one end of the second transmission cable for establishing connectivity with the voice output terminal of the cellular device.
F) A 2.5 mm male connector, located at one end of the first and second transmission cable for establishing connectivity with different adapters for the use of cellular devices with other type of input/output socket.

2. The cellular phone/vehicle stereo interface cable of claim 1, for the use with a cellular device having an input/output socket.

3. The cellular phone/vehicle stereo interface cable of claim 1 or 2 for the use with a vehicle stereo system having multiple loudspeakers or at least one functional

4) The cellular phone/vehicle stereo interface cable of claims 1, 2 or 3 for the use with a radio frequency modulator (radio transmitter) and a vehicle stereo system having one antenna for receiving radio signals.

5) The cellular phone/vehicle stereo interface cable of claims 1, 2, 3 and 4 wherein said unidirectional microphone is in alignment with the users mouth and mounted on top of the vehicle upper steering column cover.

6) The cellular phone/vehicle stereo interface cable of claims 1, 2, 3, 4 or 5 wherein said the cellular phone/vehicle stereo interface cable do not need any other power supply than the cellular device to operate the unidirectional microphone.

7) The method to service wireless one way voice communication between a cellular phone and a destination terminal (stereo system) utilizing the interface cable and a radio frequency modulator

8) The method to service direct connection for one way voice communication between a cellular phone and a destination terminal (stereo system) when connected to an audio input socket that the stereo system provides.

9) The method of using a unidirectional microphone that can operates with the interface cable to provide voice reception and feedback to the cellular phone for broadcasting.

10) The method of sharing a common ground (C) between the 2.5 mm male connector and the ground of the modulator (D) male connector and also the ground for the microphone (H) female connector.

11) The method of using diferent adapters to stablish connectivity with diferent type of input/output sockets for diferent brands of cellular phones.
